(19) United States
(12) Patent Application Publication
(10) Pub. No.: US 2005/0121425 A1
(43) Pub. Date: Jun. 9, 2005

(54) Scanner welding device comprising a vat and an inert gas supply

(75) Inventor: Wolfgang Danzer, Dorfen (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 10/971,733

(22) Filed: Oct. 25, 2004

Related U.S. Application Data
(63) Continuation of application No. PCT/EP03/04280, filed on Apr. 24, 2003.

(30) Foreign Application Priority Data
Apr. 24, 2002 (DE) 10218296.5

(51) Int. Cl. B23K 26/24; B23K 26/12

(52) U.S. Cl. 219/121.63; 219/121.64; 219/121.86

(57) ABSTRACT

The invention relates to a device for laser welding, especially for scanner welding using quilting seams. In order to maintain the welding points under inert gas during said method, the inventive device comprises a vat with an inert gas supply.

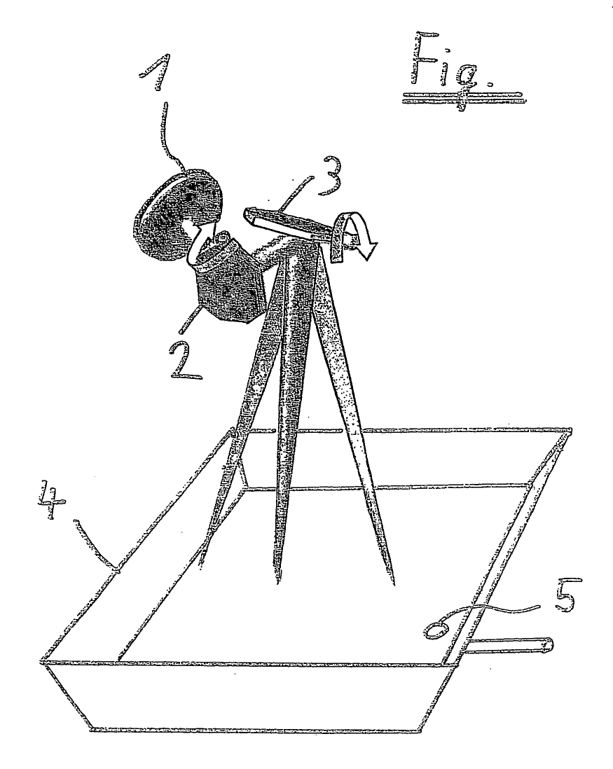

### BACKGROUND AND SUMMARY OF THE INVENTION

This application is a Continuation of PCT Application No. PCT/EP03/04280 filed Apr. 24, 2003 which claims priority to German Application No. 10218296.5 filed Apr. 24, 2002.

The invention relates to a laser welding device, particularly for the so-called scanner welding.

During laser welding, as a rule, a laser beam is focussed on the workpiece to be worked. Parallel to the lens system or in the direct vicinity thereof, a nozzle is provided for an inert gas supply so that the welding point heated by the laser beam will not come in contact with the ambient air.

So-called scanner welding is known from the brochure “Remote Welding by Means of the TRUMPF Scanner and the TLF CO₂ Laser”. This welding partially replaces the resistance spot welding which, although it is a cost-effective standard method of joining large components, it limits the design and the functionality of the joined components as a result of the large interfering contours of the gripping tools. The low torsion resistance of the spot connections may also be a disadvantage. When welding by means of a scanner, a focussed laser beam of a high beaming quality and a long focal length is freely guided over the three-dimensional workpiece. Thus, in contrast to conventional laser welding, the focusing lens system does not move here, but only the focussing point. This is achieved by a highly dynamic tilting of stationary mirrors at a large distance above the workpiece. The laser power is controlled synchronously with the movement. The laser is arranged in a range of approximately 60 cm to 1 m above the workpiece and can sweep over a workpiece area amounting to 60×60 cm to 1 x×2 m. During scanner welding, the spot connections are therefore replaced by laser-welded stitch seams, whereby, on the one hand, the strength and stiffness are increased, which leads to a reduction of the metal sheet thicknesses and reduces the weight. On the other hand, the significantly better accessibility of the laser welding process can be utilized for implementing simpler, more elegant as well as economical constructions. In the case of working lens systems guided in a Cartesian manner or by means of robots, non-productive times remain for the travels between the joining points. The travels can be eliminated by using the scanner technique.

A similar system is disclosed in the brochure “Remote Welding System, the New Freedom” of ROFIN-SINAR Laser GmbH. A CO₂ laser is also used here which has a focal length of over 1.6 m. This results in a working space in the form of a truncated pyramid with an area of 1.5 m×2.4 m.

In comparison to classic welding, laser remote welding has the disadvantage that no inert gas can be brought to the weld seam by way of the welding head. In Germany, welding therefore now takes place in ambient air in the experimental superstructures. However, the welding in ambient air has different disadvantages: Nitrogen results in the formation of pores in the weld seam; oxygen leads to an uncontrolled formation of slag. The moisture of the air is also disturbing and can result in the formation of pores caused by hydrogen.

From International Patent Document WO 90/06206, a microlaser machine is known for treating small objects, the small objects being arranged in an airtight chamber, which is then flooded with a reactive gas. However, this device is suitable only for small objects.

From European Patent Document EP 102 835 B1, a welding apparatus is known which also contains a gastight welding chamber flooded with an inert gas from below. This apparatus is also suitable only for treating relatively small objects which can be enclosed in the chamber.

It is therefore an object of the invention to suggest a laser welding device for the scanner welding of large components, which prevents the disadvantages of welding in ambient air.

According to the invention, this object is achieved by a laser welding device, particularly for the so-called scanner welding by means of stitch seams, comprising a vat-type receptacle for holding components during welding, said receptacle being open at the top, and
an inert-gas feed to the receptable.

Preferred embodiments are described herein and in the claims.

According to the invention, the component is placed in a vat-type receptacle which is open on top and is flooded with inert gas. According to the invention, the relative heaviness of the inert gas in comparison to air is utilized for this purpose, in which case the gas is guided from below into the vat-type receptacle. The parts to be welded together, for example, a car door, is then placed in the vat. In the case of the device according to the invention, the welding points are then automatically surrounded by inert gas. Since, in one embodiment, the lateral parts of the vat are higher than the component to be processed, the immersed components are always completely surrounded by the inert gas.

The gas supply can take place laterally or from above. The heavier gas will then fall into the vat like water from a faucet. In a preferred embodiment, the gas supply takes place from below in order to generate as few whirls as possible. Feeds at several points on the bottom or in the lower wall area were found to be advantageous; likewise, the supply by way of perforated hoses placed into the vat at the bottom. A higher number of openings allows a lower gas velocity and reduces the whirls. When the inert gas is then fed into this vat in a timed or continuous manner, whirling-in air, which takes place from the outside by the insertion of the components, is then displaced. According to our tests, it was determined that whirling-in air of below 5% of the vat atmosphere is not damaging.

The receptacle preferably has an area of >60×60 cm or of more than 1×2 m. This is sufficient for being able to weld commercially available car doors or similar components by means of laser stitch seams.

All gases and gas mixtures which were suggested for laser welding and which are as heavy as or heavier than air are suitable as inert gases. Argon or CO₂ or mixtures of argon and CO₂ are preferably used. It is also conceivable to use nitrogen alone or mixed with other heavy non-reactive gases.

Additional advantages and characteristics of the invention are illustrated by means of the embodiment shown in the drawing.

Other objects, advantages and novel features of the present invention will become apparent from the following detailed description of the invention when considered in conjunction with the accompanying drawings.

### BRIEF DESCRIPTION OF THE DRAWINGS

The single drawing FIGURE schematically illustrates a laser welding device according to preferred embodiments of the invention.

### DETAILED DESCRIPTION OF THE DRAWINGS

A laser beam is guided from above by way of a focusing lens 1 onto a first tilting mirror 2, whose axis of rotation is essentially vertical. From this mirror 2, the light is directed to a second rotating mirror 3 having a horizontal tilting axis. This lens system is capable of sweeping over a working range on the bottom of the device, on which the inert gas receptacle 4 is situated according to the invention. This inert gas receptacle has a flat bottom and four side walls, which are either disposed vertically, are slightly inclined toward the outside, or may be recessed toward the inside. The slight inclination toward the outside illustrated in the figure facilitates the charging of the objects from above. In the case of today's automated production lines, this no longer presents a problem to the modern robot. Vertical walls or walls which are slightly inclined toward the inside keep the inert gas pond on the bottom of the vat more stable.

A simple inert gas feed 5 is illustrated in the bottom of the receptacle 4.

For the welding according to the invention, the component or components are placed flatly in the receptacle 4. By way of the swivellable laser lens system, the stitch seams to be applied are then applied by swivelling the two mirrors 2, 3. Simultaneously, inert gas is supplied through the inert gas feed 5, so that the components to be treated will always be surrounded by inert gas. Thus, an automobile door with 30 weld seams can be joined from two metal sheets within 30 seconds.

The foregoing disclosure has been set forth merely to illustrate the invention and is not intended to be limiting. Since modifications of the disclosed embodiments incorporating the spirit and substance of the invention may occur to persons skilled in the art, he invention should be construed to include everything within the scope of the appended claims and equivalents thereof.

1. Laser welding device, particularly for the so-called scanner welding by means of stitch seams, comprising:
a vat-type receptacle for holding components during welding, said receptacle being open at the top, and
an inert-gas feed to the receptacle.

2. Device according to claim 1, wherein the sides of the receptacle are higher than the thickness of the components to be welded.

3. Device according to claim 1, wherein the gas supply to the receptacle takes place from below.

4. Device according to claim 2, wherein the gas supply to the receptacle takes place from below.

5. Device according to claim 1, wherein the receptacle has an area of >60×60 cm.

6. Device according to claim 5, wherein the receptacle has an area of >than 1 m×1 m.

7. Device according to claim 2, wherein the receptacle has an area of >60×60 cm.

8. Device according to claim 7, wherein the receptacle has an area of >than 1 m×1 m.

9. Device according to claim 3, wherein the receptacle has an area of >60×60 cm.

10. Device according to claim 4, wherein the receptacle has an area of >than 1 m×1 m.

11. Device according to claim 4, wherein the receptacle has an area of >60×60 cm.

12. Device according to claim 11, wherein the receptacle has an area of >than 1 m×1 m.

13. Device according to claim 1, comprising gases heavier than air used as inert gas fed to the receptacle by way of the inert gas feed.

14. Device according to claim 13, wherein the gases are argon or CO₂ or mixtures containing these gases and/or additional gases.

15. Device according to claim 13, wherein the sides of the receptacle are higher than the thickness of the components to be welded.

16. Device according to claim 15, wherein the receptacle has an area of >60×60 cm.

17. Laser welding apparatus comprising:
an upwardly open vat type receptacle operable to hold components to be welded,
a laser beam generating device,
a focusing lens and mirror assembly disposed above said receptacle and operable to direct laser beams from the generation device to weld components in said receptacle over a welding working area of greater than 60 cm×60 cm, and
an inert gas supply arrangement for supplying inert gas heavier than air to the receptacle to surround the components being welded.

18. Laser welding apparatus according to claim 17, wherein the sides of the receptacle are higher than the thickness of the components to be welded.

19. Laser welding apparatus according to claim 17, wherein the inert gas supply arrangement includes means for supplying inert gas to the receptacle from below the receptacle.

20. Laser welding apparatus according to claim 19, wherein the receptacle includes a flat bottom, and
wherein the inert gas supply arrangement includes at least one gas supply opening in said flat bottom.

21. Laser welding apparatus according to claim 20, wherein the inert gas supply arrangement includes a plurality of openings in said flat bottom.

22. Laser welding apparatus according to claim 21, wherein said flat bottom has an area of between 60 cm×60 cm and 1 m×1 m.

23. Laser welding apparatus according to claim 22, wherein said flat bottom has an area of greater than 1 m×1 m.

24. Laser welding apparatus according to claim 23, wherein sides of the receptacle are higher than combined thicknesses of components to be welded.

25. A method of welding a plurality of metal-components together using the apparatus of claim 17, comprising:
placing the components in the receptacle and feeding inert gas to the receptacle to cover the components, and
subsequently welding the components together by directing laser beams to the components from the laser beam generating device using the mirror assembly to move the beam over the areas of the components to be welded together.

26. The metal of claim 25, wherein the components are sheet metal components.

27. The method of claim 26, wherein the sheet metal components together form a vehicle door.

28. The method of claim 25, wherein the inert gas is argon or CO₂ or mixtures containing these gases and/or additional gases.

29. A method of making a structure composed of multiple metal parts, comprising:
placing the metal parts in an upwardly open vat type receptacle,
supplying inert gas heavier than air to the receptacle to surround portions of the metal parts to be welded, and
laser welding the metal parts together by directing laser beams via a mirror assembly onto portions of the metal parts to be welded.

30. A method according to claim 29, wherein the metal parts are sheet metal parts.

31. A method according to claim 30, wherein said structure in a vehicle door comprising two sheet metal parts which are welded together along a plurality of stitch seams.

32. A method according to claim 29, wherein the receptacle has a flat bottom with an area greater than 60 cm×60 cm and
wherein said supplying inert gas includes directing said inert gas through a plurality of openings in said flat bottom.
